(19) United States
(12) Patent Application Publication
(10) Pub. No.: US 2013/0197855 A1
(43) Pub. Date: Aug. 1, 2013

(54) METHOD AND APPARATUS TO DETERMINE TEMPERATURE OF A GAS TURBINE ENGINE

(71) Applicant: Gareth W. Oskam, San Diego, CA (US)

(72) Inventor: Gareth W. Oskam, San Diego, CA (US)

(21) Appl. No.: 13/362,998

(22) Filed: Jan. 31, 2012

(51) Int. Cl. G01M 15/14; G06F 15/00

(52) U.S. Cl. 702/135; 702/130

(57) ABSTRACT

A method for determining a location of a temperature measurement at a flow plane of a gas turbine engine. The method may include using a camera to capture at least one image of a temperature sensor disposed in the flow plane. The method may further include analyzing the image in a processing unit to obtain location data indicating a location of the temperature sensor.

### TECHNICAL FIELD

The present disclosure is directed to a system and method for measuring gas temperature of a gas turbine engine (GTE), and more particularly temperatures at an exit plane of a GTE combustion chamber.

### BACKGROUND

GTEs produce power by extracting energy from a flow of hot gas produced by combustion of fuel in a stream of compressed air. In general, turbine engines have an upstream air compressor coupled to a downstream turbine with a combustion chamber (“combustor”) in between. Energy is released when a mixture of compressed air and fuel is burned in the combustor. In a typical turbine engine, one or more fuel injectors direct a liquid or gaseous hydrocarbon fuel into the combustor for combustion. The resulting hot gases are directed over blades of the turbine to spin the turbine and produce mechanical power.

Gas temperature distribution is measured at an exit plane of the combustor in order to determine whether the combustor produces a temperature distribution which is desired or specified for the design of the GTE. In measuring the gas temperature distribution, it is desirable not only to obtain accurate point by point temperature measurements, but also to accurately determine the location of each measurement. Reducing uncertainty in the location of a measurement can in turn reduce uncertainty in the temperature observed at specific locations of the exit plane of the combustor.

U.S. Patent Application Publication No. 2011/0030215 A1 to Ponziani (the '215 publication) describes a method for determining sensor locations in GTEs. The method described in the '215 publication uses a controller configured to determine a position of each of a plurality of sensors. According to the method described in the '215 publication, sensors are fixed to an outer surface of a turbine rear frame.

### SUMMARY

In one aspect, a method for determining a location of a temperature measurement at a flow plane of a gas turbine engine is disclosed. The method may include using a camera to capture at least one image of a temperature sensor disposed in the flow plane. The method may further include analyzing the image in a processing unit to obtain location data indicating a location of the temperature sensor.

In another aspect, a method of determining and adjusting a location of a temperature measurement at a combustor exit plane of a gas turbine engine is disclosed. The method may include using at least one camera to capture an image of a radially movable temperature sensor disposed in the combustor exit plane. The method may further include analyzing the image in a processing unit to obtain location data indicating the location of the temperature sensor. Additionally, the method may include sending a command from the processing unit to an actuator to radially move the temperature sensor to a desired location in the combustor exit plane if the temperature sensor is not in the desired location.

In yet another aspect, a system for determining and adjusting a location of a temperature measurement at a combustor exit plane of a gas turbine engine is disclosed. The system may include an annular test rig disposed at the combustor exit plane. Additionally, the system may include at least one actuator mounted to the test rig, and a temperature sensor disposed on the actuator. In some embodiments, the actuator may be configured to radially move the temperature sensor within a hot gas flow path of the combustor exit plane. The system may further include at least one camera mounted to the test rig and configured to capture an image of the temperature sensor, as well as a processing unit connected to the at least one actuator and the at least one camera.

### BRIEF DESCRIPTION OF THE DRAWINGS

FIG. 1 is a schematic sectional view of a portion of an exemplary embodiment of a GTE;

FIG. 2 is a cross-sectional schematic view along line 2-2 of FIG. 1;

FIG. 3A is a magnified schematic view of a temperature measurement device of FIG. 2 arranged at a combustion chamber exit plane;

FIG. 3B is a schematic view of an actuator-camera arrangement of FIG. 2;

FIG. 4 is a flow chart of a first embodiment of steps to determine the location of a temperature measurement in a high temperature gas stream; and

FIG. 5 is a flow chart of a second embodiment of steps to determine and adjust the location of a temperature measurement in a high temperature gas stream.

### DETAILED DESCRIPTION

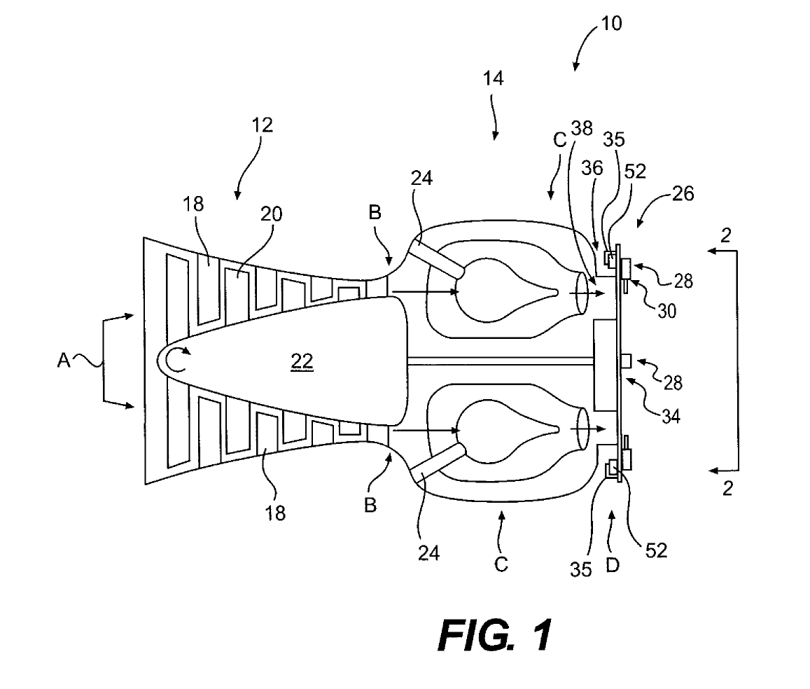

FIG. 1 illustrates a portion of an exemplary embodiment of a GTE 10, which may be used, for example, to supply power to machines, such as vehicles, power generators, and pumps. An exemplary GTE may include a compressor section 12, a combustor section 14, and a turbine section (not shown). Compressor section 12 is configured to draw air into the GTE at A and compress the air before it enters combustor section 14 at B. Compressor section 12 includes stationary blades 18 and rotating blades 20 operably coupled to a compressor hub 22. Stationary blades 18 and rotating blades 20 are shaped such that as rotating blades 20 rotate, the air is drawn through compressor section 12, so that it is compressed and acquires a higher pressure by the time the air reaches B, thereby increasing its potential energy.

The compressed air from compressor section 12 enters the combustor section 14, and fuel is supplied to the combustor section 14 via one or more fuel injector(s) 24. The fuel and air are ignited at C, thereby causing the air to expand and enter the turbine section upon exit from the combustor section 14 at combustor exit plane D. An outer combustor chamber wall 36 (referred to herein as an “outer wall”) and an inner combustor chamber wall 38 (referred to herein as an “inner wall”) of the combustion section 14 are formed at the combustor exit plane D. A test rig 26 may be provided at a flow plane of the GTE. In an exemplary embodiment, the test rig 26 may be coupled at the combustor exit plane D for measuring a gas temperature distribution in the space between the outer wall 36 and the inner wall 38 at the combustor exit plane D during operation of the combustor section 14. When the test rig 26 is coupled at the combustor exit plane D, the turbine section has been decoupled from the GTE.

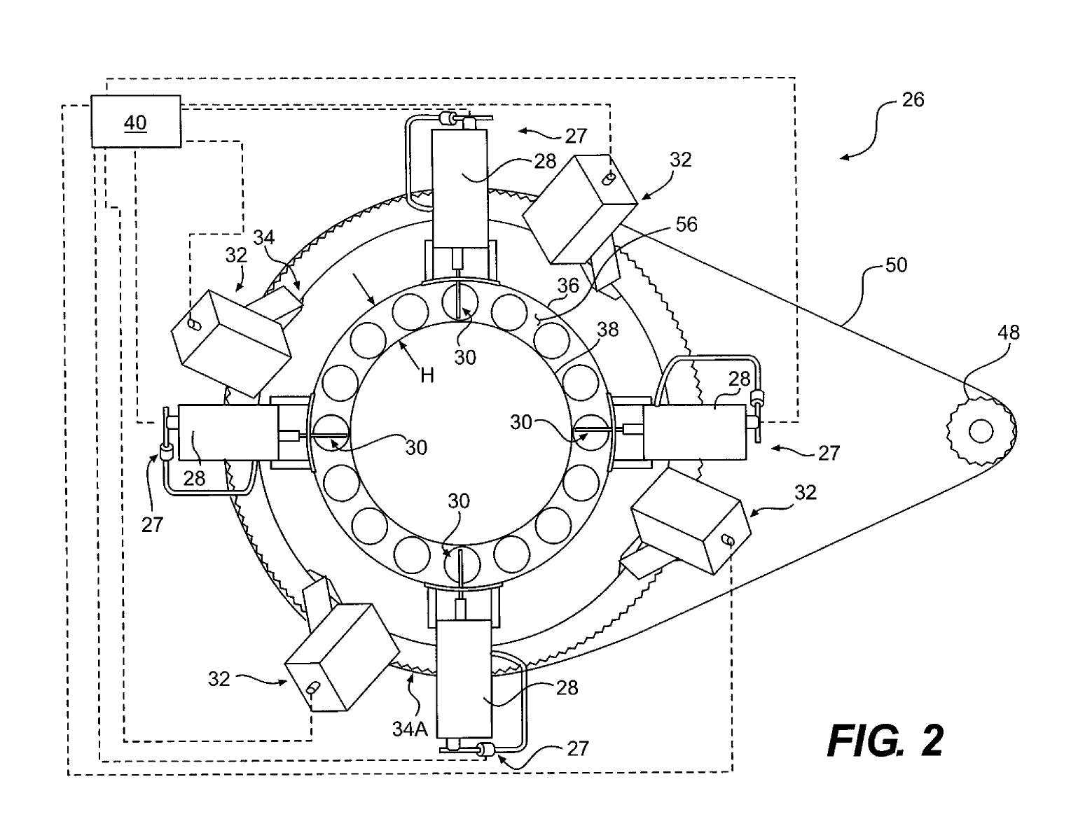

FIG. 2 is a cross-sectional schematic view along line 2-2 of FIG. 1, showing an exemplary embodiment of the test rig 26 arranged at a flow plane of the GTE. FIG. 1 shows the test rig 26 arranged at the combustor exit plane D; however, the test rig 26 could be disposed at another flow plane of the GTE 10. In some embodiments, the test rig 26 includes an annular support 34 disposed at the combustor exit plane D, where the annular support 34 may be rotatably supported by at least one mounted guide wheel 52, as illustrated in FIG. 1. An outer edge 34A of the annular support 34 may include a plurality of teeth so that the annular support 34 may be connected to a drive gear 48 via a chain 50 in order to allow for circumferential rotation around the GTE 10 of the entire annular support 34 and any components attached thereto. Additionally, the annular support 34 may include a lip 35 extending toward the combustor section 14. The lip 35 may rest on the at least one mounted guide wheel 52, as shown in FIG. 1. The lip 35 may also form a space or recess capable of receiving the at least one guide wheel 52, which, in some embodiments, may comprise a plurality of guide wheels 52. In other embodiments, the annular support 34 may be supported in any conventional manner allowing for rotation of the annular support 34.

As illustrated in FIG. 2, the test rig 26 includes at least one temperature measurement assembly 27. The temperature measurement assembly 27 includes an actuator 28 and a temperature measurement device, for example rake 30. Actuator 28 may be connected to the annular support 34 by any available fastening means, for example, nut and bolt connections. The actuator 28 may be a linear actuator disposed in or adjacent the combustor exit plane D and configured to actuate rake 30. As described in more detail below, the rake 30 may include a plurality of probes 46 having sensors 54 therein that may collect temperature data at the combustor exit plane D. As used herein, “temperature sensor” can refer to the rake 30 generally, the probes 46, and/or the sensors 54 disposed within the probes 46. The actuator 28 may be configured to move the rake 30 in a radial direction in the space 56 between the outer wall 36 and the inner wall 38 of the combustor section 14 (the space 56 referred to herein as the “hot gas flow path”). The radial distance between the combustion chamber outer and inner walls 36 and 38 at the combustor exit plane D may be referred to as the characteristic dimension H. In some embodiments, a plurality of actuators 28 may be connected around the annular support 34. For example, as shown in FIG. 2, four actuators 28 may be connected to the annular support 34 at the top, bottom, and sides of the annular support 34. The actuators 28 may be disposed generally horizontally, vertically, or at another angle on the annular support 34. Additionally, the actuator 28 may include a heat resistant protective enclosure (not shown), and/or a liquid cooling system to cool the actuators during operation.

In addition to the temperature measurement assembly 27, a camera 32 may be connected to the annular support 34 by any available fastening means, for example, nut and bolt connections. The camera 32 may be an infrared (IR) camera used to visualize the location of each probe of each rake 30 and to simultaneously collect temperature data of the combustion chamber walls 36 and 38. Furthermore, a plurality of cameras 32 may be connected around the annular support 34. For example, as shown in FIG. 2 where one camera 32 is connected to the annular support 34 for each temperature measurement assembly 27, each camera 32 may be aimed at a corresponding rake 30 of the temperature measurement assembly 27. In other embodiments, a plurality of cameras, for example a pair of cameras per temperature measurement assembly 27, may be provided. Providing a pair of cameras per temperature measurement assembly 27 would allow stereoscopic, i.e. 3-dimensional, images to be obtained in order to determine the location of temperature measurements. In some embodiments, the camera 32 may be a high definition (HD) camera, such as an HD-IR camera capable of collecting temperature and location data of the rake 30 and the combustion chamber walls 36 and 38. In other instances the camera 32 may be a visible light camera. Furthermore, the camera 32 may include a heat resistant protective enclosure (not shown) and/or a liquid cooling system to cool the cameras during operation.

As mentioned above, in some embodiments the annular support 34, along with the temperature measurement assembly 27 and cameras 32, may be rotatable with respect to the combustion chamber walls 36 and 38 at the combustor exit plane D. The drive gear 48 may be rotated, which in turn may cause the annular support 34 to rotate, in order to reposition the temperature measurement assembly 27 and cameras 32 about the combustor exit plane D to measure gas temperatures at desired circumferential locations. In some instances, rotation of the annular support 34 and the temperature measurement assembly 27 and cameras 32 provided thereon enables 360 degree temperature sensing. For instance, the drive gear 48 may be capable of rotating the annular support 34 to enable temperature measurement at any angle in 360 degrees of a plane, for example the combustion chamber exit plane D.

In order to collect data, the camera 32 may be connected to and in communication with a processing unit 40, for example a computer, for data capture and processing. As illustrated by FIG. 2, a plurality of cameras 32 may each be connected to the processing unit 40 via electrical connections, indicated by dashed lines, so that the processing unit 40 may collect data from the plurality of cameras 32. The processing unit 40 may further be connected to and in communication with the temperature measurement assembly 27. As described in more detail below, the processing unit 40 may use the data received from the camera 32 to send commands to the temperature measurement assembly 27 in order to control movement of the actuator 28 and rake 30 attached thereto. As shown in FIG. 2, in some embodiments a plurality of actuators 28 may each be connected to the processing unit 40 via electrical connections, indicated by dashed lines, so that the processing unit 40 may send and receive commands to and from each of the plurality of actuators 28.

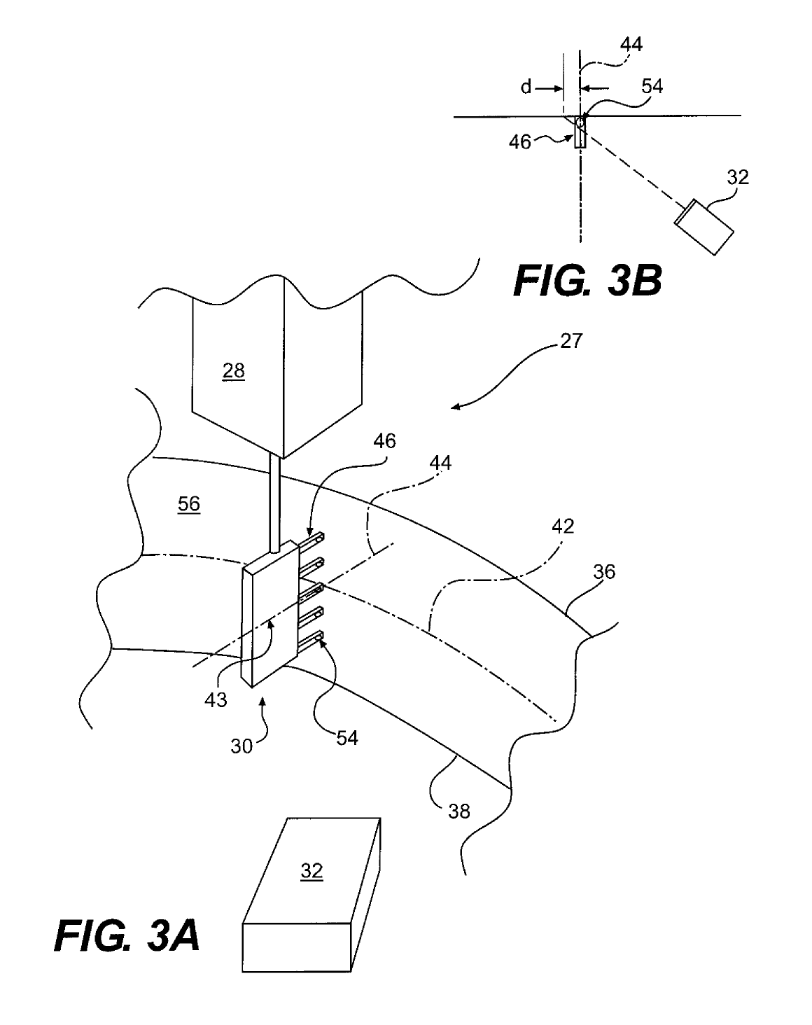

FIG. 3A is a magnified schematic view of the temperature measurement assembly 27 arranged at the combustion chamber exit plane D. As mentioned above, the temperature measurement assembly 27 may include a rake 30 having a plurality of temperature probes 46. As shown in FIG. 3A, the rake 30 may be a fork-shaped rake extending in a longitudinal direction between the combustion chamber outer and inner walls 36 and 38, where the rake 30 includes a plurality of extending temperature probes 46. Each temperature probe 46 may include a sensor 54 disposed and housed within the probe 46 for measuring gas temperature distribution in the hot gas flow path 56 between the outer and inner combustion chamber walls 36 and 38 at the combustor exit plane D. As shown in FIG. 3A, in some embodiments the sensor 54 may be located at a top of each probe 46. The rake 30 may include any number of temperature probes 46 extending towards the combustor exit plane D in order to collect gas temperature data. The number of probes 46 may depend on the size of the combustion chamber. For example, for a larger combustion chamber, a longer rake having more probes may be used, whereas for a smaller combustion chamber, a smaller rake having a lesser number of probes may be used. In one exemplary embodiment, the probes 46 extend in a direction towards the combustor section 14 of the GTE 10. Furthermore, in some alternative embodiments, each temperature probe 46 may house a plurality of sensors 54 for measuring gas temperature at the combustor exit plane D.

As shown in FIG. 3B, the camera 32 may be aimed at a midpoint 43 of the rake 30, through which a centerline 44 passes, which may be aligned with a centerline 42 between the combustion chamber walls 36 and 38 (referred to herein as the “annulus centerline”). The centerline 44 of the rake may pass through the midpoint 43 of the rake 30 in a direction perpendicular to the longitudinal direction of the rake 30. In some embodiments, as shown in FIG. 3B, the rake centerline 44 may correspond to a probe centerline passing through a probe midpoint, such that the cameras 32 may be aimed at the probe centerline. In other embodiments, the camera can be aimed at a probe centerline, where the probe centerline does not necessarily correspond to the rake centerline 44.

Each of the individual temperature probes 46 may be formed as a tube having a circular cross-section. In some embodiments, however, each of the individual probes 46 may be formed as tubes having a rectangular, for example a square, cross-section, or another cross-sectional shape. By providing, for example, circular shaped probes 46 or rectangular shaped probes 46, as shown in FIGS. 3A and 3B, a computer program of the processing unit 40 may operate to detect the locations of each probe 46 where the sensors 54 may be located, by identifying edges of the cross-section in the image obtained by the camera 32.

FIG. 3B is a schematic top view of the actuator-camera arrangement of FIG. 2, showing the camera 32 aimed at a temperature probe 46 of the rake 30. FIG. 3B illustrates a correction distance d, which, in some embodiments, may be factored into calculations in order to accurately determine the location of a probe 46. For example, if it is determined that the rake centerline 44 is offset from the annulus centerline 42 by a particular distance when it is desired that the rake centerline 44 be aligned with the annulus centerline 42, a correction distance d may be factored in (either added or subtracted) from the offset distance. This may provide a verifiable indication of the actual location of a temperature measured by the probe 46 at a corresponding sensor 54.

### INDUSTRIAL APPLICABILITY

The system described above may be used to measure temperature and determine a location of the temperature measurement in a gas flow path. For example, the above-described system may be used to measure temperature and determine a location of the temperature measurement in a hot gas flow path in a plane of a GTE, for example a combustor exit plane. Methods of measuring gas temperature and determining a location of the gas temperature measurement at a combustor exit plane of a GTE using the system will now be explained.

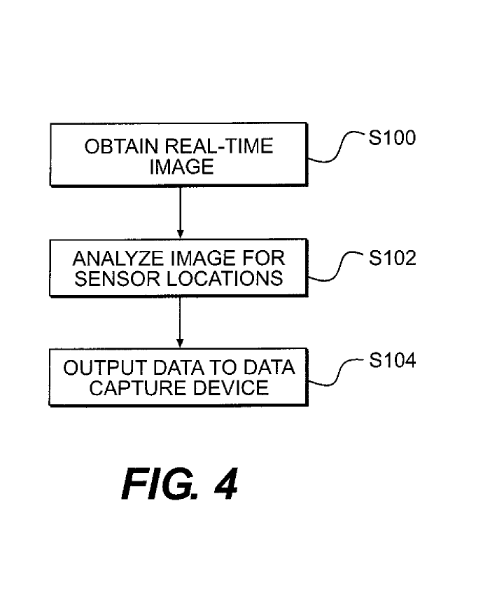

With reference to FIG. 4, one embodiment of a method of determining the location of a sensor 54 corresponding to the location of a temperature measurement in the hot gas flow path 56 is described. Each sensor 54 within each probe 46 may provide measurements of local gas temperature at the combustor exit plane D as hot gas passes over the rake 30. In a step S100, a real-time, infra-red image of the rake 30 may be obtained via the camera 32. Specifically, the image may be of the rake 30 having a plurality of probes 46 disposed in the combustor exit plane D in the hot gas flow path 56 between the combustion outer and inner chamber walls 36 and 38, respectively. As described above, an IR camera may collect both location data for each probe 46 and, simultaneously, temperature data of the combustion chamber walls 36 and 38. Moreover, the camera 32 may obtain an image showing a temperature profile between the outer combustion chamber wall 36 and the inner combustion chamber wall 38.

In Step S102, the image may be analyzed by a computer program of the processing unit 40 connected to and in communication with the camera 32 in order to determine the location of the rake 30. Because each rake 30 may include a plurality of probes 46, each probe 46 having a sensor 54, the location of the sensors 54 can be determined upon determining the location of the rake 30. In measuring the location of the rake 30, the camera 32 may monitor the location of the rake 30 relative to the combustor exit plane D in order to provide location information for each probe 46 and each corresponding sensor 54 on the rake 30. In some embodiments, location information may be provided as pixels in a magnified image, which can be displayed on a display screen of the processing unit 40. The location information of the image may be accurate to +/−1 pixel, although other accuracies may be realized. Each pixel in the image corresponds to a known unit of length. For example, 1 pixel may correspond to 32/1000 inch or, in other embodiments, 1 pixel may correspond to 16/1000 inch. In yet other embodiments, however, each pixel may correspond to another value.

As described above, the radial distance between the combustion chamber outer and inner walls 36 and 38 at the combustor exit plane D may be referred to as the characteristic dimension H. During the image analysis in step S102, the camera 32 may measure the characteristic dimension H by a number of pixels between the combustion chamber outer and inner walls 36 and 38 at a given time, which may be converted into a distance of the characteristic dimension H as a unit of length, as described above. Upon obtaining the characteristic dimension H between the walls 36 and 38, a midpoint between the walls 36 and 38 provides the location of the annulus centerline 42. A rake 30 having a known size and shape can also allow for calculation of a midpoint 43 of the rake 30. During the image analysis in step S 102, the camera 32 may capture an image of the rake 30, where a midpoint 43 of the rake 30 is known for a given rake design or shape. Therefore, a rake centerline 44 that passes through the rake midpoint 43 is also known, depending on the rake design, size, or shape. Due to the heat from the hot gas exiting the combustor section 14 through the hot gas flow path 56 at the combustor exit plane D, each of the combustion chamber outer and inner walls 36 and 38 may undergo thermal expansion, which may cause variations in the characteristic dimension H. Additionally, due to the heat from the hot gas exiting the combustor section 14 through the hot gas flow path 56, the rake 30 and probes 46 attached thereto may undergo thermal expansion, which may cause variations in the location of the rake centerline 44. The method of adjusting the location of a temperature measurement, described in more detail below, can automatically account for these changes.

Once the annulus centerline 42 and the rake centerline 44 are known, the location of each probe 46, and thus the location of each sensor 54, may be determined relative to the annulus centerline 42 and the rake centerline 44. The characteristic dimension H, which enables the measurement of the annulus centerline 42, and the rake centerline 44 may thus provide sufficient information required to determine the location of each probe 46, and thus the location of each sensor 54, within the hot gas flow path at the combustor exit plane D.

As mentioned above with respect to FIG. 3B, a correction distance d may be obtained and used to accurately determine the location of a sensor 54 of a probe 46. Depending on the aim of the camera 32 with respect to the rake 30, the measured sensor location may be adjusted by the correction distance d if, for example, the camera 32 does not directly intersect the sensor 54.

In a step S104, the location and temperature data obtained by the camera 32 may be output to a processing unit 40, for example a programmable computer, connected to and in communication with the camera 32. As described above, the processing unit 40 may be connected to and in communication with a plurality of cameras 32 and thus able to obtain location and temperature data output from each of the plurality of cameras 32. Accordingly, the processing unit 40 may receive and display, on an image display screen, both sensor location and temperature measurement data recorded at the combustor exit plane D.

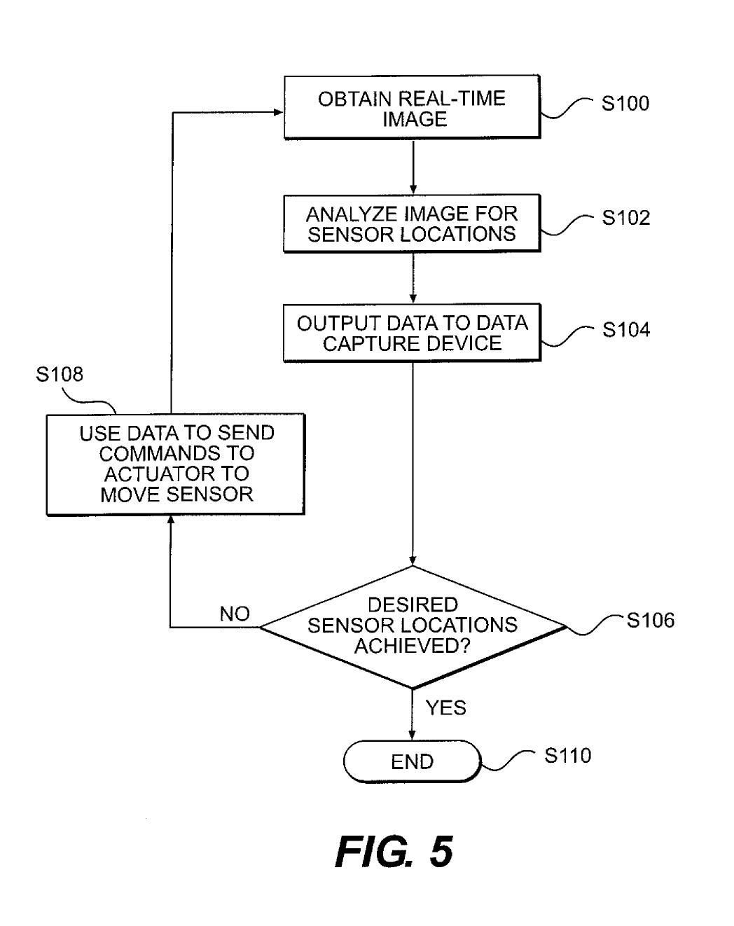

With reference to FIG. 5, a method of automatically determining and adjusting the location of a temperature measurement in a high temperature gas stream is described. Steps S100 to S104 in FIG. 5 are the same as those described with respect to the flow chart of FIG. 4, and therefore they will not be repeated with regard to FIG. 5.

In some instances, there may be a desired predetermined location for temperature measurement in the hot gas flow path 56, which may be programmed into the processing unit 40. For example, temperature measurements may be desired where the rake centerline 44 is aligned with the annulus centerline 42. In a step S106, using the location data obtained from the images, an algorithm of the processing unit 40 may be automatically implemented to align the rake centerline 44 with the annulus centerline 42. The algorithm of the processing unit 40 may automatically determine whether the desired location has actually been achieved. If the desired location has been achieved, for example, if the rake centerline 44 is aligned with the annulus centerline 42, the process proceeds to a step S110 and ends. If, however, the processing unit 40 determines that the desired location has not been achieved, the process proceeds to a step S108. In step S108, via feedback control, the processing unit 40 uses the data obtained in step S104 to automatically send commands to the actuator 28 to move the rake 30 to the predetermined, desired location in the hot gas flow path 56, for example to align the rake centerline 44 with the annulus centerline 42. After the processing unit 40 moves the rake 30 via the actuator 28 in the step S108, the process repeats, beginning at step S100, until the desired rake location, and thus a desired temperature measurement location, is achieved. As mentioned above, the method described herein may automatically control the location of a temperature measurement, for example by aligning a rake centerline 44 with an annulus centerline 42, while accounting for any changes in the location of the rake centerline 44 due to thermal expansion. As also mentioned above, the rakes 30 and cameras 32 may be repositioned, manually or automatically, by circumferential rotation of the test rig 26 about the GTE, in order to obtain temperature and location measurements at a variety of locations in the combustor exit plane D.

The disclosed methods allow for real-time, verifiable determinations of the location of a temperature measurement in a high temperature gas stream of a GTE. While point-by-point temperature measurement at an exit plane of a combustor section of a GTE should be as accurate as practically possible, certainty of the location of each temperature measurement is also important in order to collect accurate data regarding the gas temperature distribution at the exit plane. By providing a system and method for more accurately mapping the temperature in the hot gas exhausted from the combustion section, errors in temperature and stress calculations for turbine components can be minimized. This, in turn, may reduce uncertainty in component life calculations, which may reduce loss of parts due to premature failure during operation, and therefore reduce overall costs. Additionally, the disclosed system and methods allow for automatic adjustment of the location of temperature measurements via feedback control from a processing unit, as described above, during a test.

The system and methods described above may be applied to any GTE. Furthermore, while GTEs are one example, the system and methods described above may be applicable in any industry where accurate location of high temperature gas measurements is required, such as process industries and semi-conductor manufacturing.

It will be apparent to those skilled in the art that various modifications and variations can be made to the disclosed system and method of measuring temperature in a high temperature gas stream. Other embodiments will be apparent to those skilled in the art from consideration of the specification and practice of the disclosed system and method. For example, in other embodiments, the actuator can be omitted and the location of a gas temperature measurement at a combustor exit plane may be used to calculate actual locations, which can be used in subsequent calculations of the hot gas stream. It is intended that the specification and examples be considered as exemplary only, with a true scope being indicated by the following claims and their equivalents.

What is claimed is:

1. A method of determining a location of a temperature measurement at a flow plane of a gas turbine engine, comprising:
using a camera to capture at least one image of a temperature sensor disposed in the flow plane; and
analyzing the image in a processing unit to obtain location data indicating a location of the temperature sensor.

2. The method of claim 1, wherein the capturing comprises:
capturing an image of a plurality of temperature sensors disposed in the flow plane, each of the plurality of temperature sensors disposed in a hot gas path located between an inner combustion chamber wall and an outer combustion chamber wall.

3. The method of claim 1, wherein the capturing comprises:
capturing a plurality of images of a plurality of temperature sensors, and the flow plane being a combustion chamber exit plane.

4. The method of claim 1, wherein the capturing comprises:
capturing an infra-red image of the temperature sensor, an inner combustion chamber wall, and an outer combustion chamber wall.

5. The method of claim 1, further comprising:
moving the temperature sensor circumferentially around the flow plane to a second location in the flow plane;
using the at least one camera to capture another image of the temperature sensor; and
analyzing the another image in the processor to obtain location data indicating the second location of the temperature sensor.

6. The method of claim 1, wherein the location data comprises pixels of the image, each pixel corresponding to a unit of length.

7. The method of claim 1, wherein the capturing comprises:
capturing both temperature data at the flow plane and the location data simultaneously.

8. The method of claim 1, wherein the analyzing comprises:
determining a centerline of a combustion chamber annulus from a measured radial distance between a combustion chamber inner wall and a combustion chamber outer wall,
wherein the location of the temperature sensor is measured relative to a centerline associated with the temperature sensor and the centerline of the combustion chamber annulus.

9. The method of claim 1, further comprising measuring temperatures at a plurality of different radial locations located in the flow plane, the flow plane being located between an inner combustion chamber wall and an outer combustion chamber wall.

10. A method of determining and adjusting a location of a temperature measurement at a combustor exit plane of a gas turbine engine, comprising:
using at least one camera to capture an image of a radially movable temperature sensor disposed in the combustor exit plane;
analyzing the image in a processing unit to obtain location data indicating the location of the temperature sensor; and
sending a command from the processing unit to an actuator to radially move the temperature sensor to a desired location in the combustor exit plane if the temperature sensor is not in the desired location.

11. The method of claim 10, wherein the analyzing comprises:
determining a centerline of a combustion chamber annulus from a radial distance between a combustion chamber inner wall and a combustion chamber outer wall.

12. The method of claim 11, wherein sending the command moves the temperature sensor so that a predetermined centerline of the temperature sensor is aligned with the centerline of the combustion chamber annulus.

13. The method of claim 10, wherein the capturing comprises:
capturing an image of a plurality of temperature sensors disposed in the combustor exit plane, each of the plurality of temperature sensors disposed in a hot gas path located between an inner combustion chamber wall and an outer combustion chamber wall.

14. The method of claim 10, wherein the capturing comprises:
capturing a plurality of images of a plurality of temperature sensors disposed in the combustion chamber exit plane.

15. A system for determining and adjusting a location of a temperature measurement at a combustor exit plane of a gas turbine engine, comprising:
an annular test rig disposed at the combustor exit plane;
at least one actuator mounted to the test rig;
a temperature sensor disposed on the actuator, wherein the actuator is configured to radially move the temperature sensor within a hot gas flow path of the combustor exit plane;
at least one camera mounted to the test rig and configured to capture an image of the temperature sensor; and
a processing unit connected to the at least one actuator and the at least one camera.

16. The system of claim 15, wherein the temperature sensor includes a plurality of sensors, wherein each one of the plurality of sensors is disposed in one of a plurality of probes.

17. The system of claim 16, wherein each of the plurality of probes has either a circular cross-section or a rectangular cross-section.

18. The system of claim 15, further comprising a gear, the gear connected to the test rig so that the test rig is configured to rotate about the combustor exit plane of the gas turbine engine upon rotation of the gear.

19. The system of claim 15, wherein the at least one actuator comprises a plurality of actuators, and wherein the at least one camera comprises a plurality of cameras.

20. The system of claim 15, wherein the processing unit is configured to receive temperature and location data from the at least one camera, and wherein the processing unit is further configured to automatically send commands to the at least one actuator to move the temperature sensor to a predetermined location within the hot gas flow path.
